(19) United States
(12) Patent Application Publication
(10) Pub. No.: US 2014/0124305 A1
(43) Pub. Date: May 8, 2014

(54) CONTROL-BY-WIRE HYDRAULIC BRAKE STRUCTURE OF BICYCLE

(71) Applicant: TEKTRO TECHNOLOGY CORPORATION, Changhua (TW)

(72) Inventor: Szu-Fang Tsai, Changhua (TW)

(73) Assignee: TEKTRO TECHNOLOGY CORPORATION, Changhua (TW)

(21) Appl. No.: 13/669,473

(22) Filed: Nov. 6, 2012

(51) Int. Cl. B62L 3/02; B62L 1/10

(52) U.S. Cl. 188/72.4

(57) ABSTRACT

The present invention relates to a control-by-wire hydraulic brake structure of bicycle, which includes a caliper portion that is coupled to two brake shoes that are opposite to and spaced from each other; and a transmission portion, which has an end connected to the caliper portion to control the operation of the two brake shoes of the caliper portion and includes a fluid reservoir, a piston, and a transmission arm. The piston is movably received in the fluid reservoir. The transmission arm has an end pivotally connected to an end of the fluid reservoir that is distant from the caliper portion. The piston has an end that is connected to a predetermined location between two ends of the transmission arm. The transmission arm has an end that is distant from the pivotal connection with the fluid reservoir and is operatively coupled to a brake wire.

### TECHNICAL FIELD OF THE INVENTION

The present invention generally relates to the field of bicycle brake, and more particularly to a control-by-wire hydraulic brake structure of bicycle.

### DESCRIPTION OF THE PRIOR ART

Generally speaking, a structure that is adopted in a bicycle to achieve an effect of braking by hydraulic transmission can be classified as a control-by-wire hydraulic brake, where a brake grip is provided with a brake wire that is connected to a transmission component, and a fully hydraulic brake structure, where a transmission components are directly installed in the brake grip and the transmission components comprise at least a fluid reservoir, a piston, and connection rod (or a transmission arm), in which the transmission components are operatively coupled to the brake unit and the brake unit comprises at least one caliper (or clamping arm) and two brake shoes.

The present invention is made to provide a control-by-wire hydraulic bicycle brake structure that comprises a brake wire provided at a brake grip for connecting a transmission component to actuate a brake unit. A known prior art related to such a structure will be discussed in the following.

Taiwan Utility Model Publication No. 476324 discloses a master cylinder structure for bicycle disc brake, which features easy installation and excellent resistance against penetration and leakage. Internal threading is formed on an external circumference of a front section of a mounting seat and internal threading is formed inside a corresponding tubular section. The mounting seat forms a space for receiving a spring. A guide slot is formed in the space at a location close to a front end to receive an O-ring to fill therein. A brake wire coupler has a front section from which an elongate bar section extends into the tubular section to abut a hydraulic cylinder body and has an end forming a head. The head forms a fixing hole longitudinally extending therethrough to receive a fixing bolt to engage therein to fix a brake wire. The head forms a recess inside the fixing hole to receive an opening rim of a dust cap to fit therein.

However, the brake wire is directly coupled to a piston. When a user wishes to make an adjustment of the brake wire, such as stretching the brake wire, the piston is also caused to move, making hydraulic fluid access hole blocked thereby converting the interior of the hydraulic cylinder into a closed system, thereby leading to abnormality of gas lock.

In view of this problem, the present invention aims to provide a solution to overcome such a drawback.

### SUMMARY OF THE INVENTION

Thus, an object of the present invention is to provide a control-by-wire hydraulic brake structure of bicycle that aims to overcome the above discussed problem and reduces the manufacturing cost, is easy to install and remove, requires no fluid piping, and thus eliminates loss of power during transmission made through the fluid piping.

To achieve the above object, the present invention provides a control-by-wire hydraulic brake structure of bicycle, which comprises a caliper portion; and a transmission portion, which has an end connected to the caliper portion to control the operation of the caliper portion. The transmission portion comprises a fluid reservoir, a piston, a transmission arm, and a push bar. The piston is movably received in the fluid reservoir. The transmission arm is arranged outside the caliper portion. The transmission arm has an end pivotally connected to an end of the fluid reservoir that is distant from the caliper portion. The piston has an end that is connected to a predetermined location between two ends of the transmission arm. The transmission arm has an end that is distant from the pivotal connection with the fluid reservoir and operatively coupled to a brake wire.

The fluid reservoir is provided externally with a brake wire adjusting knob. The brake wire extends from the end of the transmission arm that is distant from the fluid reservoir through the brake wire adjusting knob to couple to a brake grip of a bicycle. The transmission arm and the push bar are coupled to each other with a fixing button. The fixing button controls the transmission arm for selective releasing or fixing. The brake wire adjusting knob has a function for adjusting the length and tension of the brake wire.

The caliper portion and the transmission portion are integrated with each other.

The caliper portion is coupled to two brake shoes that are opposite to and spaced from each other. The transmission portion has an end connected to the caliper portion to control operation of the two brake shoes of the caliper portion.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a partial exploded view of a control-by-wire hydraulic brake structure of bicycle according to the present invention.

FIG. 2 is a partial cross-sectional view of the control-by-wire hydraulic brake structure of bicycle according to the present invention.

FIG. 3 is a perspective view of the control-by-wire hydraulic brake structure of bicycle according to the present invention.

FIG. 4 is also a perspective view of the control-by-wire hydraulic brake structure of bicycle according to the present invention taken at a different angle.

FIG. 5 is a cross-sectional view of the control-by-wire hydraulic brake structure of bicycle according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

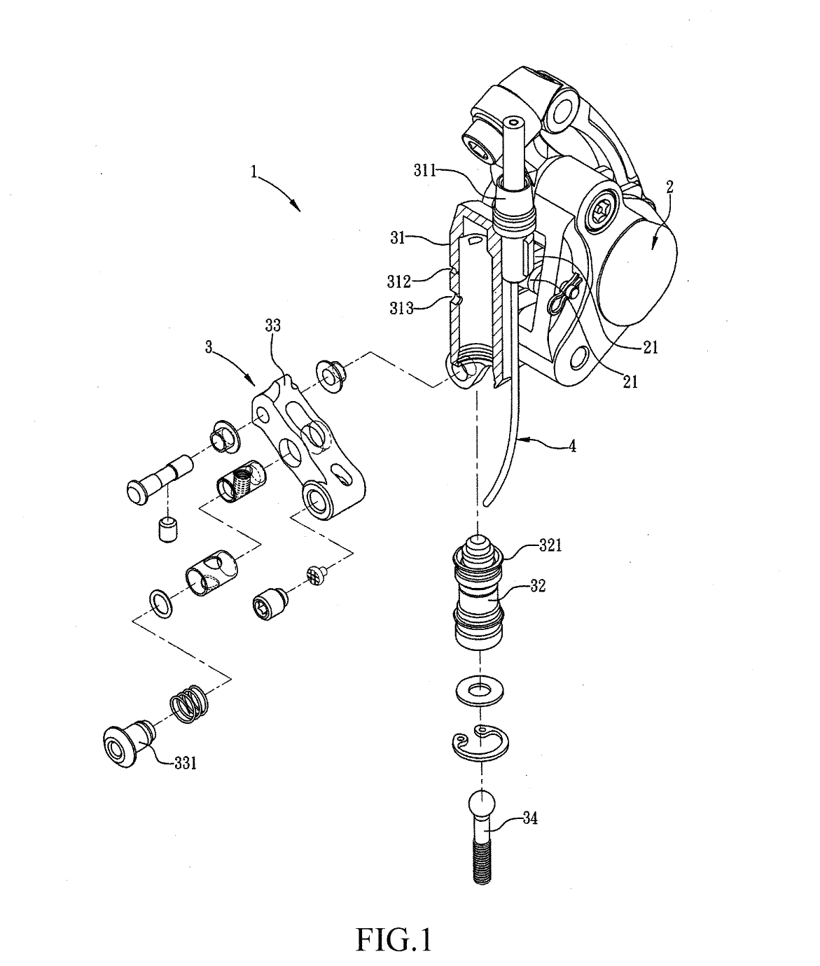

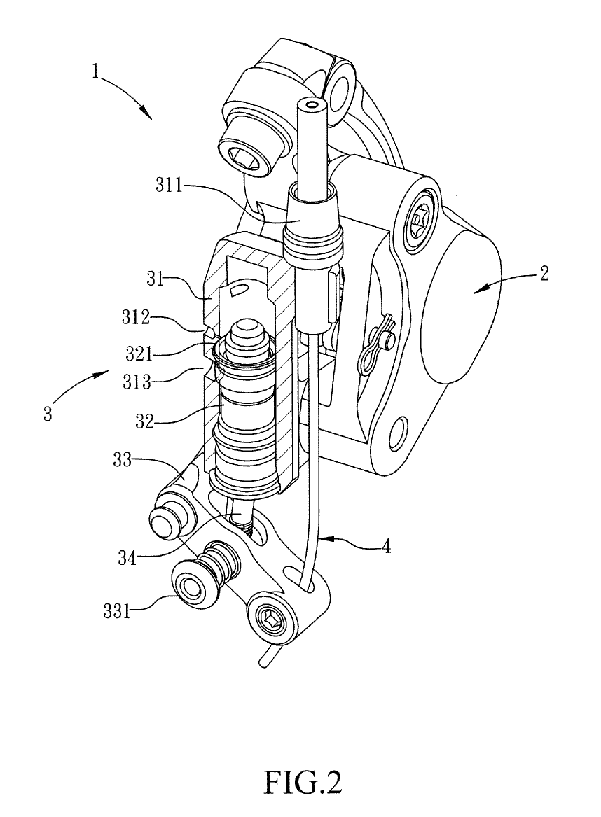

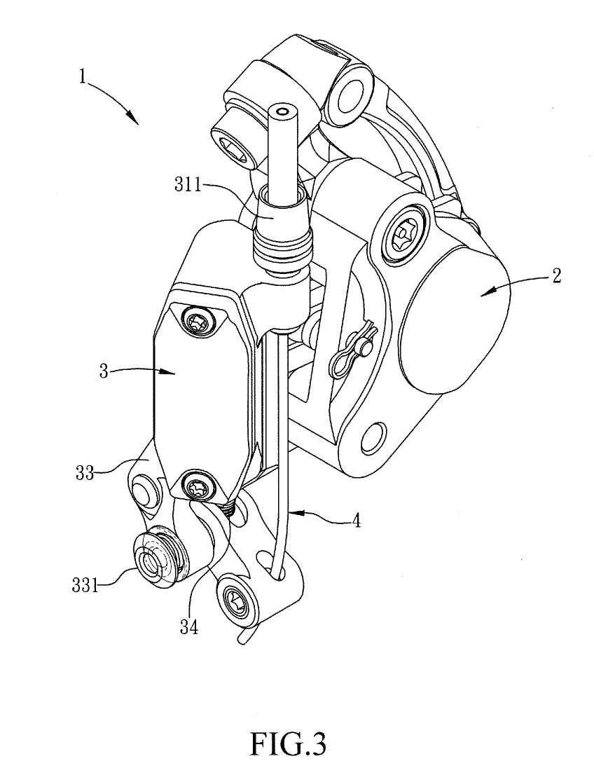

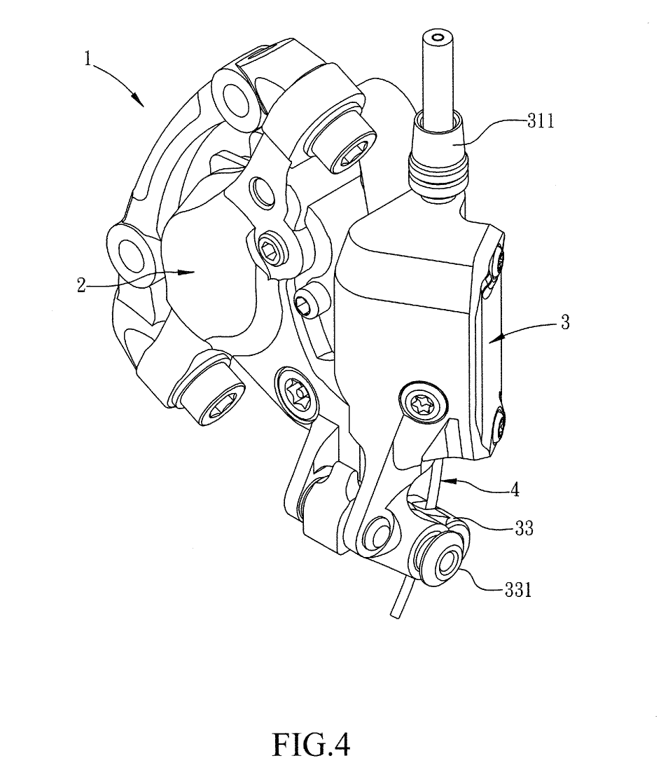

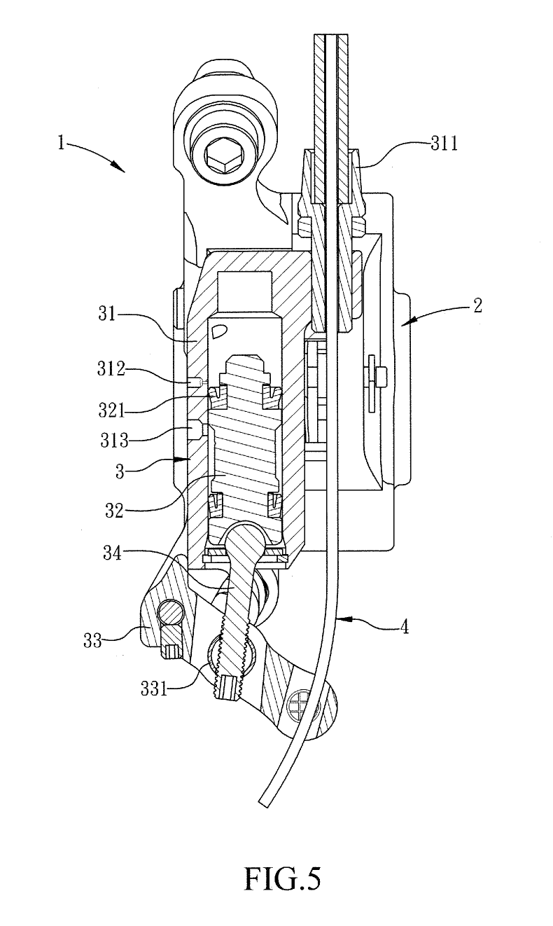

Referring to FIGS. 1-5, FIG. 1 is a partial exploded view of a control-by-wire hydraulic brake structure of bicycle according to the present invention; FIG. 2 is a partial cross-sectional view of the control-by-wire hydraulic brake structure of bicycle according to the present invention; FIG. 3 is a perspective view of the control-by-wire hydraulic brake structure of bicycle according to the present invention; FIG. 4 is also a perspective view of the control-by-wire hydraulic brake structure of bicycle according to the present invention taken at a different angle; and FIG. 5 is a cross-sectional view of the control-by-wire hydraulic brake structure of bicycle according to the present invention.

The present invention provides a control-by-wire hydraulic brake structure of bicycle, generally designated at 1, which comprises a caliper portion 2 and a transmission portion 3. The caliper portion 2 and the transmission portion 3 can be integrated with each other but not limited to such an arrangement.

The caliper portion 2 is coupled to two brake shoes 21 that are opposite to and spaced from each other.

The transmission portion 3 has an end connected to the caliper portion 2 to control the operation of the two brake shoes 21, of which details will be described hereinafter.

Further, the transmission portion 3 comprises a fluid reservoir 31, a piston 32, a transmission arm 33, and a push bar 34. The fluid reservoir 31 is filled with a hydraulic fluid. The piston 32 is movably received in the fluid reservoir 31. The transmission arm 33 is arranged outside the caliper portion 2. The transmission arm 33 has an end pivotally connected to an end of the fluid reservoir 31 that is distant from the caliper portion 2. The piston 32 has an end that is connected via the push bar 34 to a predetermined location of the transmission arm 33 between two ends of the transmission arm. The predetermined location can be close to the end of the transmission arm 33 that is pivotally connected to the fluid reservoir 31, but not limited to such an arrangement. The transmission arm 33 has an end that is distant from the pivotal connection with the fluid reservoir 31 and is operatively coupled to a brake wire 4.

Further, the fluid reservoir 31 is provided externally with a brake wire adjusting knob 311. The brake wire 4 extends from the end of the transmission arm 33 that is distant from the fluid reservoir 31 through the brake wire adjusting knob 311 to couple to a brake grip of a bicycle (both not shown). The transmission arm 33 and the push bar 34 are coupled to each other with a fixing button 331. The fixing button 331 makes a control of the transmission arm 33 for selective releasing or fixing. The brake wire adjusting knob 311 has a function for adjusting the length and tension of the brake wire 4. The fluid reservoir 31 forms a small hole 312 at a location adjacent to the brake wire adjusting knob 311. The fluid reservoir 31 also forms a large hole 313 at a location away from the brake wire adjusting knob 311. In other words, in a regular condition, the fixing button 331 is set in a released condition so that the transmission arm 33 is in operative coupling with the brake wire 4 to cause a movement of the piston 32. When it is desired to adjust the brake wire 4, the fixing button 331 is pressed down to show a fixed condition thereby fixing the transmission arm 33. The brake wire adjusting knob 311 may then be used to make adjustment of length and tension of the brake wire 4. Such a structure is simple and does not cause a seal 321 that is located one end of the piston 32 adjacent to brake wire adjusting knob 311 to block the small hole 312 and thus making the interior of the fluid reservoir 31 a closed system that might lead to abnormality of gas lock.

Thus, when a rider presses down the brake grip (not shown) to stretch the brake wire 4 (this being a mechanical operation), the transmission arm 33 is caused to rotate in a direction toward the fluid reservoir 31, causing the push bar 34 to drive the piston 32 to move in a direction toward the caliper portion 2, and eventually, a hydraulic way is taken to control the two brake shoes 21 of the caliper portion 2 to approach each other (this being a hydraulic operation) so as to achieve the effect of braking.

With the above described structure, the present invention provides a caliper portion 2 and a transmission portion 3 that are combined with each other for coupling with an existing brake wire 4 of a bicycle, whereby there is no need to connect fluid piping to a brake grip of the bicycle for driving a piston (also referring the prior art) and loss of power caused by transmission through the fluid piping can be reduced. In addition, easy installation and removal can be achieved and the manufacturing cost can be reduced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A control-by-wire hydraulic brake structure of bicycle, comprising:
a caliper portion; and
a transmission portion, which has an end connected to the caliper portion to control the operation of the caliper portion, the transmission portion comprising a fluid reservoir, a piston, a transmission arm, and a push bar, the piston being movably received in the fluid reservoir, the transmission arm being arranged outside the caliper portion, the transmission arm having an end pivotally connected to an end of the fluid reservoir that is distant from the caliper portion, the piston having an end that is connected via the push bar to a predetermined location between two ends of the transmission arm, the transmission arm having an end that is distant from the pivotal connection with the fluid reservoir and operatively coupled to a brake wire.

2. The control-by-wire hydraulic brake structure of bicycle as claimed in claim 1, wherein the fluid reservoir is provided externally with a brake wire adjusting knob, the brake wire extending from the end of the transmission arm that is distant from the fluid reservoir through the brake wire adjusting knob to couple to a brake grip of a bicycle, the transmission arm and the push bar being coupled to each other with a fixing button, the fixing button controlling the transmission arm for selective releasing or fixing, the brake wire adjusting knob having a function for adjusting the length and tension of the brake wire.

3. The control-by-wire hydraulic brake structure of bicycle as claimed in claim 1, wherein the caliper portion and the transmission portion are integrated with each other.

4. The control-by-wire hydraulic brake structure of bicycle as claimed in claim 1, wherein the caliper portion is coupled to two brake shoes that are opposite to and spaced from each other, the transmission portion having an end connected to the caliper portion to control operation of the two brake shoes of the caliper portion.
